(19) United States
(12) Patent Application Publication
(10) Pub. No.: US 2009/0296387 A1
(43) Pub. Date: Dec. 3, 2009

(54) LED RETROFIT LIGHT ENGINE

(75) Inventors: William Reisenauer, Commack, NY (US); Wojciech Pawelko, Deer Park, NY (US); Stefano Caposecco, Cinnaminson, NJ (US); Eric Borden, Mount Laurel, NJ (US); Andrzej Dulijas, Moorestown, NJ (US); Douglas R. Bray, Medford Lakes, NJ (US); Henry F. Villaume, Intervale, NH (US)

Correspondence Address: CASELLA & HESPOS, 274 MADISON AVENUE, NEW YORK, NY, 10016, US

(73) Assignee: Sea Gull Lighting Products, LLC, Riverside, NJ (US)

(21) Appl. No.: 12/472,887

(22) Filed: May 27, 2009

Related U.S. Application Data
(60) Provisional application No. 61/056,126, filed on May 27, 2008.

(51) Int. Cl. F21V 21/00; F21V 11/00

(52) U.S. Cl. 362/235; 362/249.02

(57) ABSTRACT

A light engine is provided including a thermally conductive housing including a generally cylindrical wall defining a cavity, the cylindrical wall includes an inner surface and an outer surface, a plurality of ducted passageways being axially disposed on the outer surface, a light module including at least one light emitting diode (LED) for producing visible light, the light module coupled to a first end of the housing, wherein heat generated by the at least one LED is conducted to the housing, and a current driver circuit arranged on a substrate, the substrate configured to be disposed in the cavity of the housing and electrically coupled to the light module for providing current to the at least one LED. The ducted passageways aid in convective heat dissipation through a “chimney” type of affect.

### PRIORITY

This application claims priority to an application entitled “LED RETROFIT LIGHT ENGINE” filed in the United States Patent and Trademark Office on May 27, 2008 and assigned Ser. No. 61/056,126, the contents of which are hereby incorporated by reference.

### BACKGROUND

1. Field

The present disclosure relates generally to light bulbs, lamp assemblies and lighting fixtures, and more particularly, to a light emitting diode (LED) based light engine that can replace a conventional A19 (Edison base) standard light bulb or a conventional compact fluorescent light (CFL) bulb used in interior and exterior light fixtures with no modifications to the host light fixture.

2. Description of the Related Art

Incandescent light bulbs are used in a wide variety of lighting fixture products. Although inexpensive to purchase, incandescent light bulbs have several drawbacks. First, incandescent light bulbs use a relatively large amount of power compared to other lighting technologies (e.g. LED or CFL) which increases energy costs. Second, incandescent light bulbs have a relatively short life causing repetitive replacement costs. Furthermore, in commercial applications, there are labor costs associated with maintenance personnel constantly replacing the light bulbs.

Because of their relatively low efficiency in generating light (95% of energy is actually turned into heat with only 5% producing light), incandescent bulbs are actually being banned through government regulations at local and federal levels, in several countries around the world. In addition, states such as California have established regulations for new building construction (e.g., Title 24 for commercial and residential buildings) that require minimum levels of lighting energy efficiency which essentially prohibits incandescent bulbs from being used in any large quantity within a building.

Compact fluorescent light (CFL) bulbs, while offering 2-3 times the energy efficiency over incandescent light bulbs, due to their design and light emission properties, can pose limitations in overall efficacy when combined with a light fixture. In addition, CFL bulbs contain mercury (a long term environmental issue) and are often slow to warm up to produce rated light levels. CFL bulbs have received mixed reviews from consumers (e.g., aesthetic appearance, light color, noise), though the technology has continued to improve.

A recent trend in the lighting industry is to develop light emitting diode (LED) engines or modules that can be easily adapted to current light fixture products. LED technology offers 3-5 times the energy efficacy of traditional incandescent bulbs and has 25 times the reliability. This offers a potentially large savings in energy consumption in interior and exterior lighting applications. In addition, LEDs produce light which is more “directional”, enabling LED light engine designers to customize the luminous intensity profile for various applications, further enhancing overall light fixture efficacy. While LED technology is generally more expensive, there can be substantial savings in energy cost, bulb replacement and maintenance costs over a multi-year period.

To date, a number of “socket based” LED products have entered the market to retrofit in place of incandescent bulbs. Some of these products use large numbers of lower power LEDs or fewer numbers of high power LEDs. Generally, these products have had relatively low light output in replacing common light fixture incandescent sources (e.g. 75 W bulb) and poor thermal management properties required to ensure long LED life. In addition, many of these light sources are highly directional and not compatible with many decorative light fixtures (e.g. pendants) detracting from the aesthetic appearance of the fixture and the LED light source.

Thus, a need exists for an LED retrofit lighting product having low power consumption, high light output and effective means for heat dissipation when used within semi-enclosed light fixture products. Such a product should have a light distribution profile to maximize light where it is needed, look aesthetically pleasing when viewed through a lamp shade or diffuser and adequately illuminate the light fixture shade to maintain a high quality decorative appearance. Furthermore, such a product should be a screw-in replacement for an incandescent or CFL bulb for easy retrofit into the existing installed base of light fixtures in residential and commercial applications.

### SUMMARY

An LED based light engine designed to be easily retrofitted into existing incandescent or CFL based light fixtures, compatible with either an Edison or Gu-24 socket is provided. The LED based light engine of the present disclosure allows much greater energy efficient lighting to be offered in residential and commercial markets while utilizing the current inventory (many thousands) of light fixture designs.

According to an aspect of the present disclosure, the LED based light engine includes an LED light module for producing light and a housing for supporting the LED light module and integrated electronic driver board. The housing includes a heat sink mechanism (e.g., central core and ducted fin assembly) for moving heat away from the LEDs and the electronic components via conduction and convection methods. The engine further includes a GU-24 compatible electrical connector base which can be used directly in GU-24 compatible light fixtures or, with the use of a GU-24 Adapter, (such as the adapter disclosed in U.S. Pat. No. 7,125,159 entitled “Non-defeatable fluorescent adapter for incandescent fixture”, the contents of which are incorporated by reference), can be used with standard Edison socket based fixtures. The LED engine also has a globe type diffuser assembly to achieve the desired aesthetic appearance and luminous intensity profile.

The LED light engine of the present disclosure produces ˜500 lumens using 27-0.5 W LEDs or 5-3 W type high power LEDs with a glass or plastic globe shaped high efficiency (85%) diffuser. When installed in pendant or other interior and exterior light fixtures, the LED light engine is designed to functionally replace the “lighting effect and utility” of a 75 W incandescent A19 bulb (1000 lumens) while consuming only 10 watts (16% of the energy consumed by the 75 W incandescent bulb—an 84% energy savings). The “lighting effect and utility” means providing similar lighting luminous intensity in the direction of the primary surfaces intended to be illuminated (e.g. countertop, table, stairwell, foyer, walkway, etc.) and uniformly illuminating the fixture shade to maintain its decorative effect. However, actual luminous intensity projected through the shade/diffuser may be lower than when using the incandescent bulb being replaced.

The LED light engine is designed for two color temperature points: ˜3000K (residential applications) and ˜4000K (commercial applications).

The LED light engine, when illuminated and viewed through the shade or diffuser, is intended to replicate a more traditional “orb” in appearance as created with an incandescent bulb. This lighting characteristic helps ensure retrofit compatibility with the installed base of fixtures and provides an aesthetic appearance that consumers are more accustomed to.

The design of the LED module and electronic driver are designed to support standard 120VAC line voltage and is compatible with a range of standard wall dimmer products (e.g. Lutron). There are two types of drive electronics used: a high efficiency (86%) linear driver circuit to supply constant current (50 mA) to the 27-0.5 W LEDs and a switching regulator circuit (80% efficiency) to supply constant current (700 mA) to the 5-3 W LEDs. Both of these circuit designs are compatible with off-the-shelf electronic low voltage (ELV) type phase control dimmers. Both circuits have high Power Factors (>0.70).

The overall LED light engine efficacy is between 35 lumens/Watt (3000K CCT) and 43 lumens/Watt (4000K CCT).

An optimized heat sink design is provided with the present disclosure which is driven by several key requirements: a) heat sink length and width is limited to dimensions of typical incandescent and CFL bulbs, b) support 10 Watts of heat dissipation in ambient temperature environments of up to 40° C. and c) support cooling when installed in existing pendant type and exterior fixtures that generally restrict convective airflow. The design objective is to keep the LED junction temperatures under 85° C. and the electronic case temperature under 70° C. to ensure long product life (>35,000 hours with 70% lumen maintenance).

In one embodiment, the heat sink/housing includes a cylindrical wall having an inner and outer surface along the axial direction of the cylindrical wall. An interior of the cylindrical wall is configured to house electronics for providing power the LEDs of the light engine. A plurality of ducts or air passageways are formed on the outer surface of the cylindrical wall to allow heat generated by the light engine to be dissipated and to facilitate the flow of ambient air though the housing to, in effect, cool the light engine. In this embodiment, the housing is of unitary construction and is extruded from a highly conductive material, e.g., aluminum.

In another embodiment, the heat sink uses a high thermal conductivity material (e.g., copper) for a base enclosure and fin components. A “lazy ruffle” fin design, enclosed in a shroud provides for convective heat flow “ducts” that creates a chimney effect to increase airflow into the heat sink and helps drive air currents within a light fixture shade (e.g. a pendant fixture). The shroud or outer surface also serves to enhance the LED light engine's aesthetic qualities (i.e., hides the heat sink's fins) and is formed of a color which aids in reflecting light back toward the light fixture shade to help in further obscuring the heat sink mechanism when viewed through the light fixture shade.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a perspective view of a LED light engine in accordance with an embodiment of the present disclosure;

FIG. 2 is a side view of a LED light engine, showing the globe diffuser, in accordance with an embodiment of the present disclosure;

FIG. 3 illustrates the LED light engine with an adapter which allows the LED light engine to become compatible with a standard Edison screw base;

FIG. 4 is a perspective view of the adapter shown in FIG. 3;

FIG. 5 is an exploded view of the LED light engine showing various internal components;

FIG. 6 is another side view of the LED light engine in accordance with the present disclosure;

FIG. 7 is a sectional view of the LED light engine shown in FIG. 6 taken along line D-D;

FIG. 8 is a sectional view of the LED light engine shown in FIG. 6 taken along line F-F;

FIG. 9 is a sectional view of the LED light engine shown in FIG. 6 taken along line E-E;

FIG. 10 is a graph showing the relative luminous intensity profiles comparing the LED light engine of the present disclosure to a 75W incandescent bulb and a 9W CFL bulb;

FIG. 11 is the schematic diagram of the constant current switching regulator board to drive 5 high power LEDs in accordance with an embodiment of the present disclosure;

FIG. 12 is the schematic diagram of the linear driver board to provide constant current drive for 27 low power LEDs in accordance with an alternative embodiment of the present disclosure;

FIG. 13 is a perspective view of a heat sink system illustrating a base enclosure and fins in accordance with an embodiment of the present discourse;

FIG. 14 is a perspective view of the “lazy ruffle” fin material shown in FIG. 13; and

FIG. 15 is a perspective view of the LED light engine showing the lazy ruffle fins covered in a shroud; and

FIG. 16 is a cross sectional view of an LED light engine in accordance with the present disclosure as installed in a typical light fixture and illustrating the airflow through the LED light engine and the light fixture.

### DETAILED DESCRIPTION

Preferred embodiments of the present disclosure will be described herein below with reference to the accompanying figures. In the following description, well-known functions or constructions are not described in detail to avoid obscuring the invention in unnecessary detail. Throughout the drawings/figures, like reference numerals represent like elements.

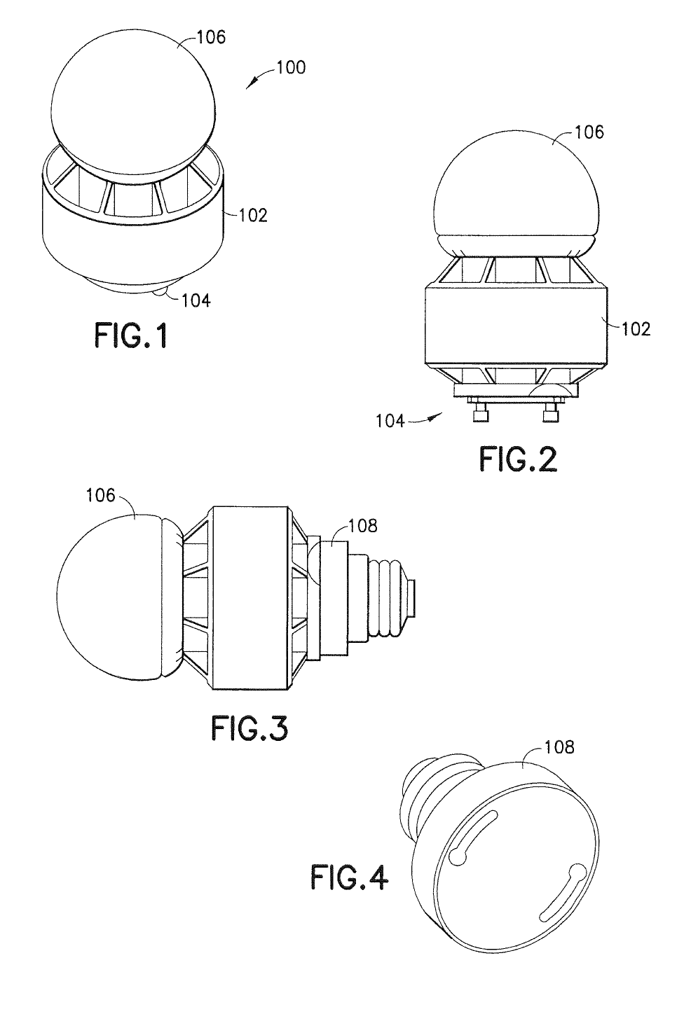

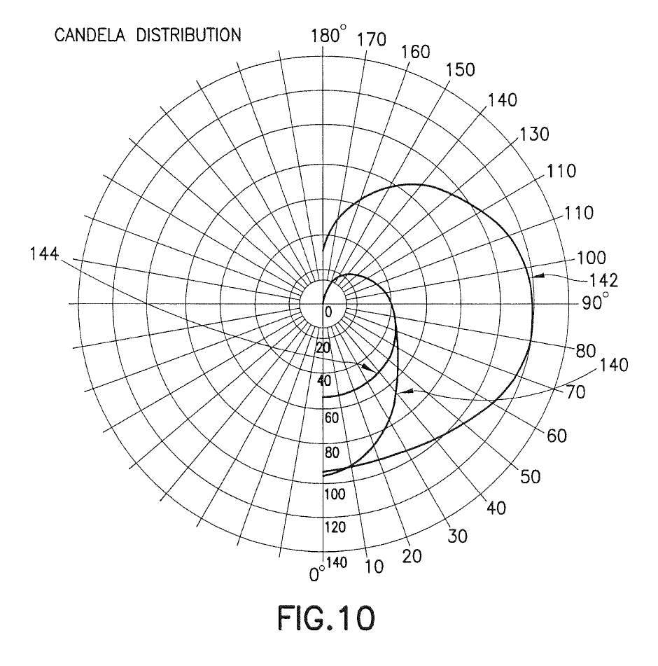

Referring to FIG. 1, an embodiment of the LED light engine 100 of the present disclosure is illustrated as a replacement for a traditional A19 incandescent or CFL lamp. The LED light engine is intended to provide a much more energy efficient and reliable alternative to an incandescent or CFL bulb. It is designed to provide approximately 500 lumens of light energy, while consuming only 10 Watts, to replace the equivalent illumination performance of a 75 W (1000 lumen) A19 bulb as installed in a typical light fixture. This is achieved by controlling (narrowing) the luminous intensity profile as compared to a standard A19 or CFL bulb, yet allowing enough light to be emitted in all directions to create a traditional light source visual effect (e.g., “orb” effect) and to enhance the decorative features of the host light fixture. The optical diffuser 106 shown in FIG. 1 directs the light from the LED module (as shown in FIG. 10) to achieve the described lighting performance.

Referring to FIGS. 1 and 2, the LED light engine 100 generally includes a housing 102, a power connector interface 104 and a diffuser 106. The housing/heat sink 102 mechanically supports all internal and external components of the light engine 100 and provides for heat dissipation to permit the LED light engine to operate in semi-enclosed fixtures (such as a pendant light fixture) in ambient air temperatures of up to 40° C. at altitudes of up to 5,000 ft. The lower portion of the LED light engine 100 includes a GU-24 style power connector interface 104, which is becoming a standard for high efficiency lamp devices. Additionally, using a GU-24 adapter 108 as shown in FIGS. 3 and 4, the LED light engine is made compatible with standard Edison medium base light sockets. The overall dimensions of the LED light engine 100 are similar in maximum height and width to the traditional incandescent lamp products being replaced, which ensures compatibility with the existing installed base of light fixtures.

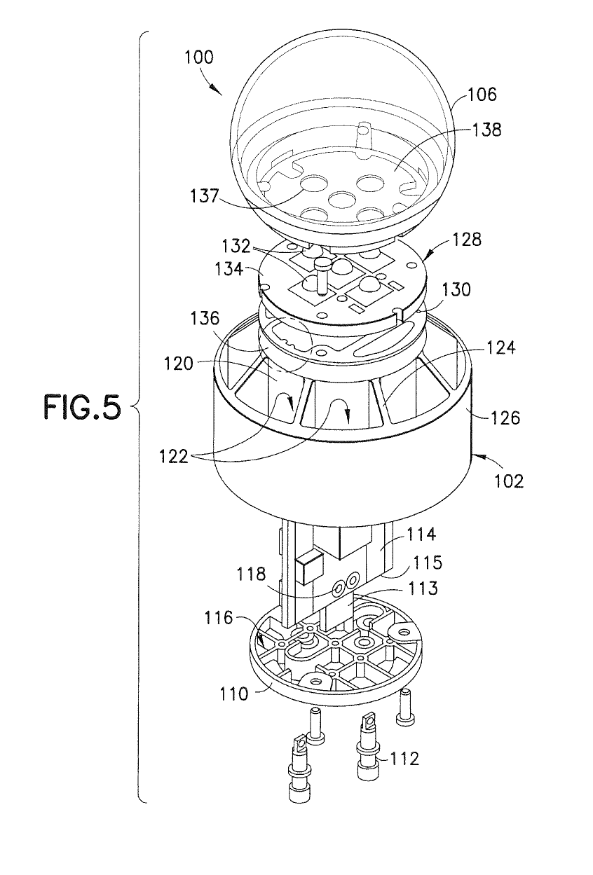

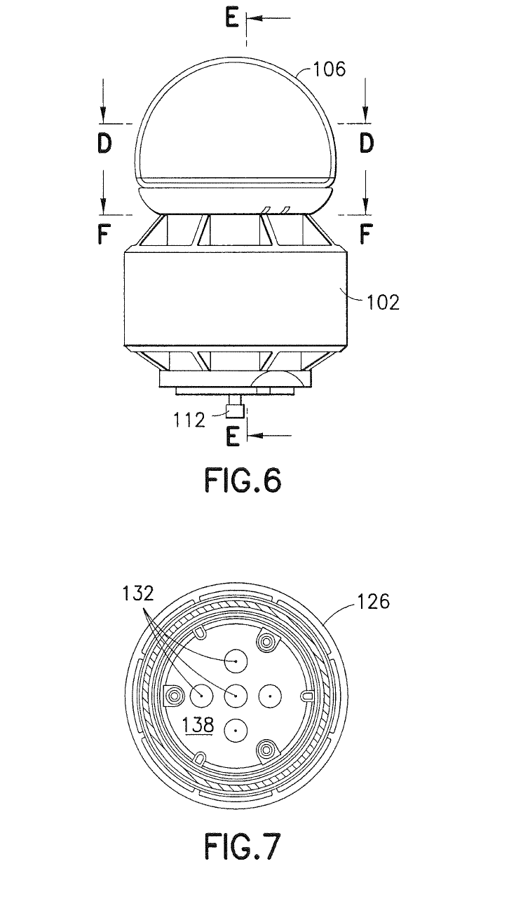

Referring to FIG. 5, an exploded view of the LED light engine 100 is illustrated, where the components of the engine will be described from the bottom up. Additionally, FIGS. 6-9 illustrate several sectional views of the light engine. A circular base 110 is provided to receive at least two contacts 112, e.g., GU 24 contacts. The base 110 is dimensioned to be coupled to conventional adapters such as the adapter shown in FIG. 4 and to fit within conventional light fixtures. The base 110 receives and supports a lower end 113 of a controller printed circuit board (PCB) 114. The lower end 113 is received by the base 110 while a remaining edge portion 115 rests upon a top surface 116 of the base 110. The controller PCB 114 includes at least two contact terminals 118 for coupling the controller PCB 114 to contacts 112, via for example wires (not shown).

The controller PCB 114 is housed in housing 102. The housing 102 is generally cylindrical and includes a cylindrical wall 120 with a plurality of ducts 122 axially surrounding the cylindrical wall 120. The ducts 120 are formed from a plurality of fins 124 radically extending from the cylindrical wall 120 and then being covered by a continuous outer surface 126. The outer surface 126 may be formed from a reflective material to reflect light emitted by an LED. It is to be appreciated that the housing 102 may be of a unitary construction and may be formed from an extrusion process. A lower portion of the cylindrical wall 120 of the housing is configured to mate with the base 120 while the controller PCB 114 is disposed within.

A LED module 128 is disposed on an upper portion 130 of the cylindrical wall 120 of the housing 102. A thermal adhesive may be applied to the upper portion 130 to secure the module 128 to the housing 102 and to facilitate the transfer of heat generated by the module 128 away from the module 128. It is to be appreciated that the LED module 128 may be attached by several methods to ensure good thermal conductivity including screws, thermal grease, thermal epoxy or combination of these methods.

The LED light module or source 128 includes a plurality of LEDs 132 mounted on a ceramic printed circuit board (PCB) 134. The ceramic PCB 134 provides high thermal conductivity when attached to the housing/heat Sink 102 and is electrically insulating to provide a high dielectric barrier between the PCB traces and the electrically conductive heat sink. The LEDs 132 may be of a single color temperature (e.g. 3000K or 4000K) or a combination of color temperatures to arrive at desired CCT values. FIG. 5 illustrates one embodiment for the LED module 128 using 5 high power LEDs such as CREE XRE 3.5V, 3 W LEDs mounted on a metal core or ceramic PCB 134. In an alternative embodiment, 27 low power LEDs such as Nichia NS4L107E 14V LEDs 132 are mounted on a ceramic printed circuit board (PCB) 134. It is to be appreciated the number of LEDs used may varying and will depend on applications of the LED light engine.

The planar LED module 128 emits light in a 90° lambertian pattern. The optical diffuser 106 mounts over the planar LED module 128 and attaches to a outer peripheral surface 136 of the upper portion 130 of the housing 102. The diffuser 106 is made of glass or plastic and has high optical efficiency of 85% or more. The diffuser 106 causes some of the LED emitted light to be directed at wider angles as depicted 140 in the luminous intensity profile (candela distribution) diagram of FIG. 10, which also shows comparison to luminous intensity profile of standard A19 75 W incandescent bulb 142 and a 9 W CFL bulb 144. As illustrated, the LED light profile 140 has a similar luminous intensity as the 75 W incandescent bulb at 0° (out the top of the lamp) and lower luminous intensities at larger angles. The diffuser is a customized spherical type design for production, optimized for the LED array design and to accomplish required luminous intensity profile.

LED PCB insulator 138 is provided to protect the printed circuit board (PCB) 134 and any electrical traces thereon. The insulator 138 can be made from any known insulating plastic and is dimensioned to be of substantially the same diameter as the printed circuit board (PCB) 134. It is to be appreciated the insulator 138 will be configured with a number of apertures 137 that correspond to the number of LEDs 132 used so that when the insulator 138 is mated with the printed circuit board (PCB) 134 the LEDs 132 will be disposed through the apertures 137.

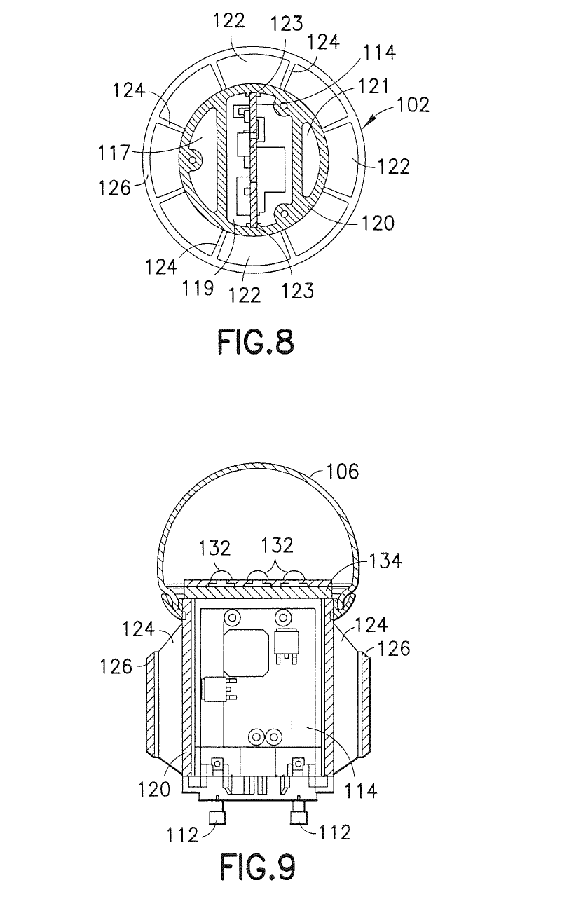

Referring to FIG. 8, a linear electronic driver circuit is mounted inside the LED light engine heat sink 102 on controller PCB 114. The cavity of the housing 102 includes a first, second and third portions or cavities, cavities 117, 119 and 121 respectively. As can be seen, the controller PCB 114 is disposed in the second cavity 119. The inner surface of the cylindrical wall 120 includes at least two channels 123 for rigidly supporting the substrate or controller PCB 114 in the housing 102. The channels 123 also serve to provide a chassis ground connection through suppression filters (capacitors) on the PCB 114. In one embodiment, the second cavity 119 is filled with potting material after the controller PCB 114 is disposed within. The potting materials insulates the controller PCB 114, aids in thermal heat transfer from the controller PCB 114 to the housing 102, secures the controller PCB 114 so it does not move and attenuates any noise generated by the components mounted on the controller PCB 114.

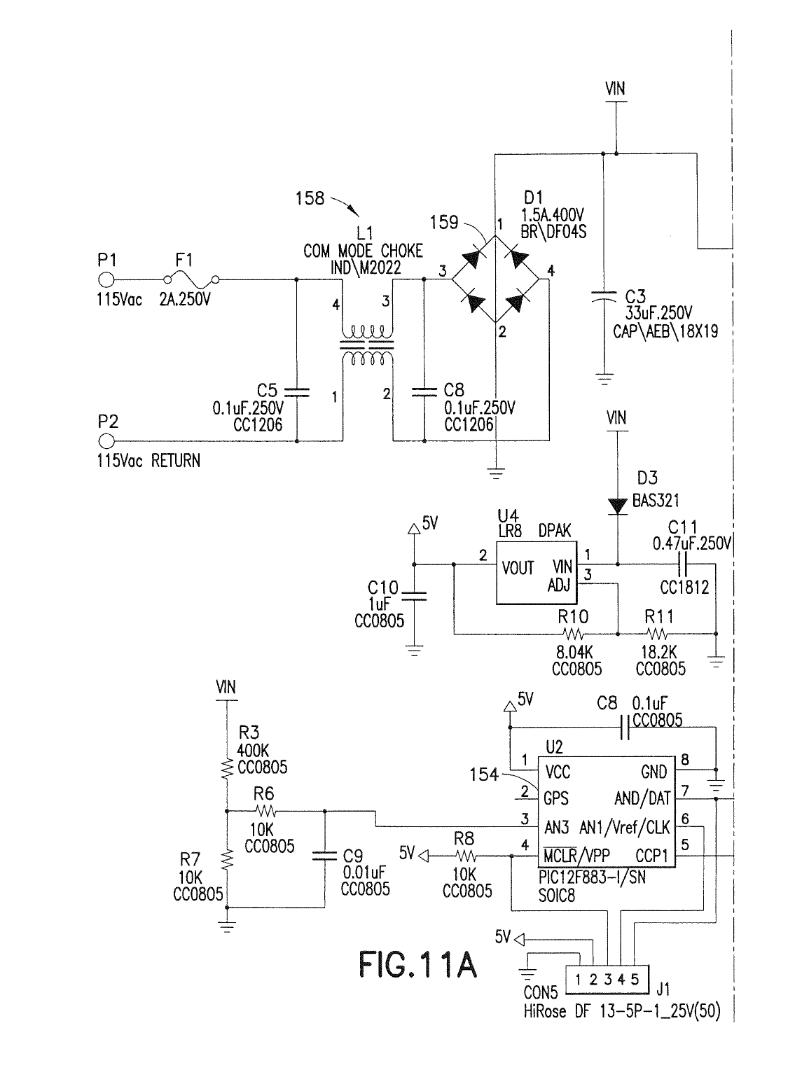

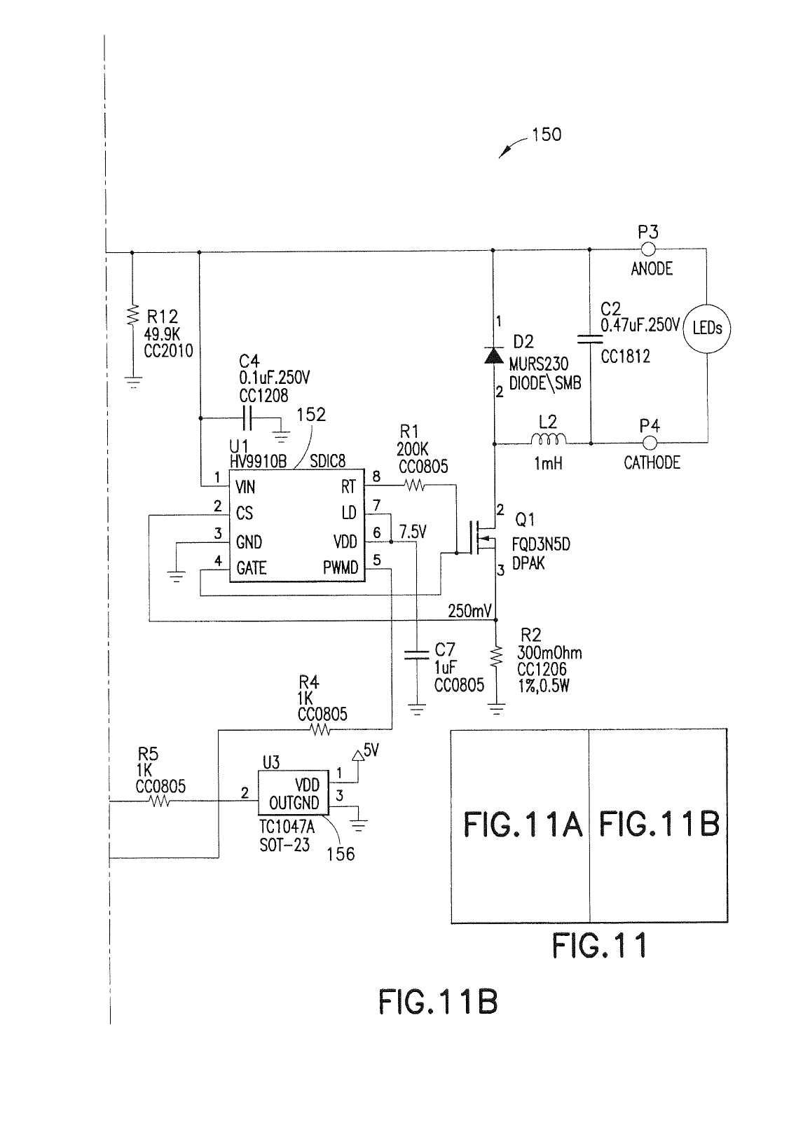

A driver circuit schematic diagram 150 is shown in FIG. 11. The circuit shown is a switching regulator circuit 150 using a Supertex HV9910 (152) architecture intended to drive 5 high power LEDs (e.g. Cree XRE's) at approximately 500 mA from 120VAC input power. This circuit is designed to provide dimming by using a comparator or microprocessor 154 to detect the presence and absence of adequate input voltage (caused by the dimmer) and commanding off the current to the LEDs. EMI filtering via common mode choke 158 is provided to meet the requirements of FCC Class A/B, before the rectifier bridge 159. This design also provides a temperature sensor 156 to detect overheat conditions and to lower the power consumed by the LEDs (e.g., dim the LEDs) to keep overall system temperatures within specification limits to ensure long service life. If the temperature sensor 156 senses a temperature above a predetermined threshold, current to the LEDs will be reduced or completely shut off.

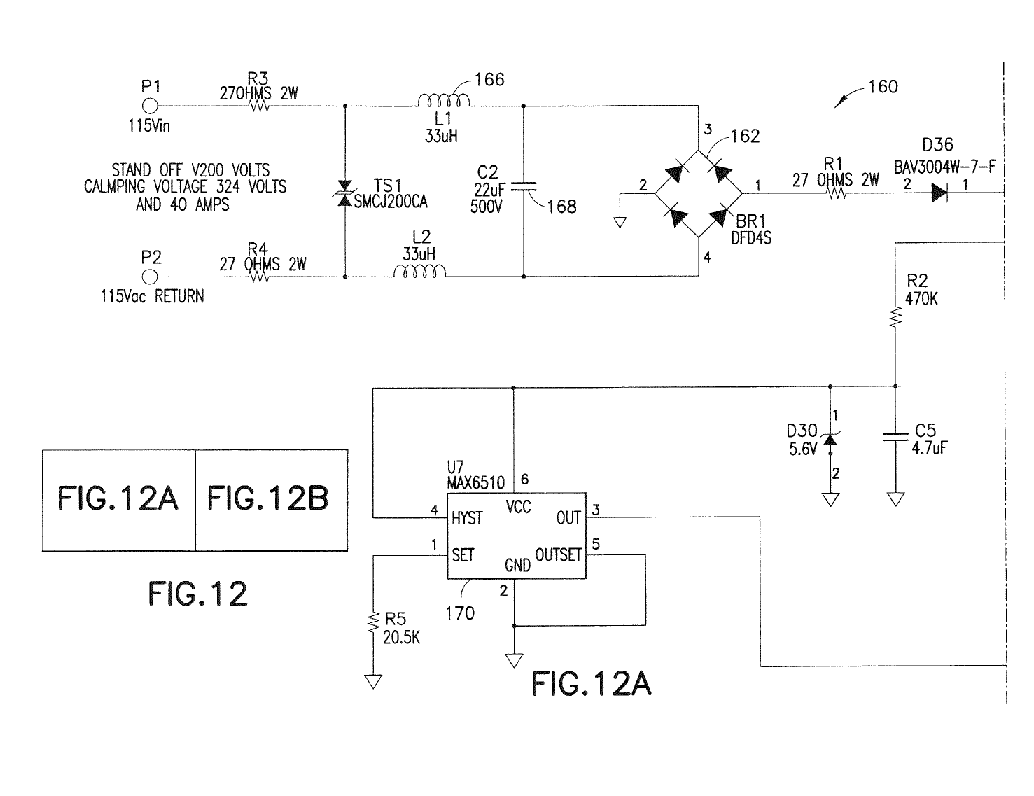

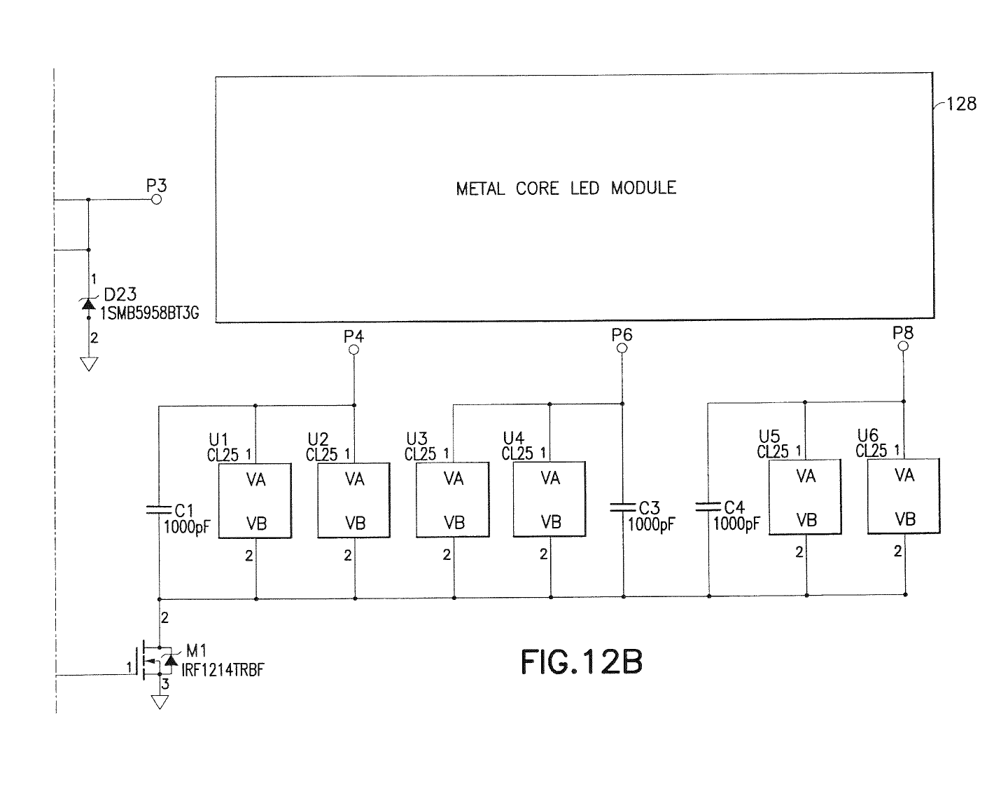

An alternative electronic constant current driver 160 is shown in the schematic of FIG. 12. This circuit is designed to input 120VAC from standard utility power sources and convert it to a 50 mA constant current required of the LEDs 132 on LED module 128. The input AC waveform is rectified by a bridge 162. The circuit drives three parallel chains of 9 LEDs in each. There are six Supertex CL25 linear regulator devices 164 that provide 50 mA constant current to each LED chain over the 120VAC input voltage range. This ensures that the LEDs are driven within their specification current range. The circuit will not power the LEDs during parts of the AC input waveform where the input voltage drops below the combined forward voltage required of the 9 LED in each chain, thus the circuit operates on an approximate 45% duty cycle. The circuit is designed to provide 85% or greater electrical conversion efficiency. Spike and transient protection is provided by an RLC filter 166 and transient suppressor device 168. A temperature sensor device 170 is used to sense PCB temperatures over 85° C. and shut off power to the LEDs via MOSFET 172. This provides protection to the LED light engine if used in an application that provides inadequate airflow for convective cooling. Depending on the host light engine design and light fixture application, a microprocessor or controller can be provided and programmed to reduce LED on time (effective power) in proportion to temperature, or alternatively, if the sensed temperature arises above a predetermined threshold value, the current driver circuit shuts off current to the light module 128.

This enables the light engine to stay within its temperature design parameters to ensure long, reliable service life. This circuit is designed to meet EMI requirements of FCC Class A/B.

The switching regulator circuit of FIG. 11 and the linear drive circuit as shown in FIG. 12 are dimmable through a standard Electronic Low Voltage (ELV) type dimmer used in-line with the 120VAC line voltage input. For the part of the input power AC waveform that the dimmer interrupts (phase period), the drive circuit will also shut down. This 120 hz equivalent interruption in voltage causes the LED light to dim, proportional to the dimmer's selected dimming position.

The electronics design of both embodiments are designed to provide a Power Factor greater than 0.7.

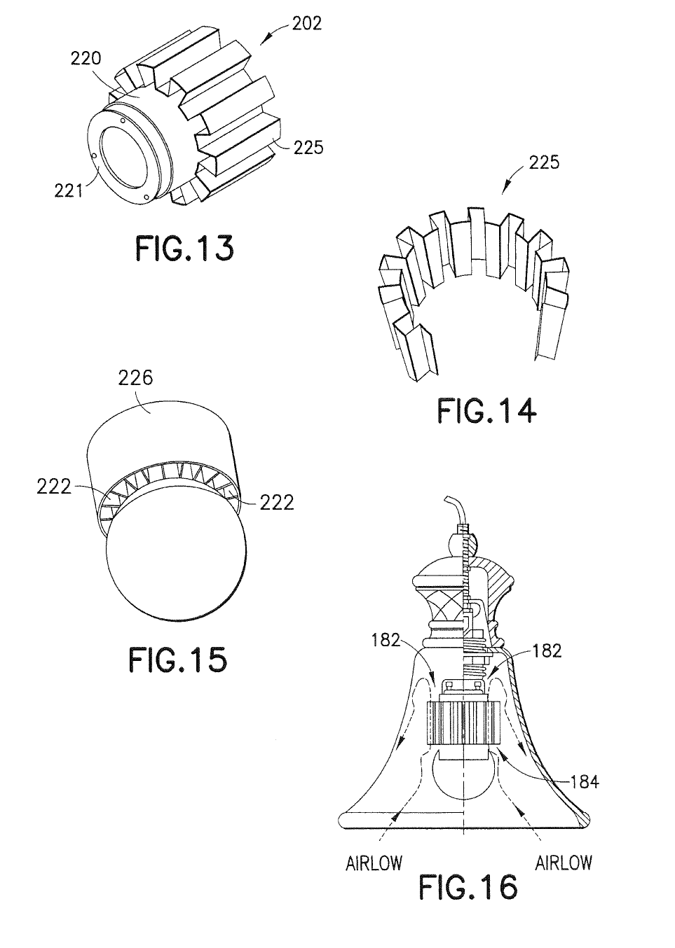

Referring to FIGS. 13-15, another embodiment of the LED housing/heat sink 202 is depicted. The heat sink is designed to provide the product's core structure to which other system components are mounted to minimize space/volume utilization and to provide thermal paths to maximize thermal management effectiveness. This thermal management system is designed to dissipate the 10 Watts generated by the LEDs and internal electronics in ambient temperature conditions of up to 40° C. and 5,000 foot altitude, while keeping the case temperature of the LED light engine under 85° C. On average, for normal ambient temperature conditions (25° C.), the system is designed to keep LED junction temperatures under 85° C. and the electronics case temperature under 95° C. to ensure long product life (35,000 hours with 70% lumen maintenance).

In the embodiment shown, the cylindrical wall 220 of housing 202 is made of copper and has a top disc 221, made of copper, and soldered to the cylindrical wall 220, to which the LED module 128 is mounted. Other materials can be used for these components such as aluminum AL6063-T5 or a composite material such as aluminum with an internal layer of pyrolytic (highly oriented) graphite. The top disc or portion 221 maximizes the surface area in contact with the LED module 128. As described above, the LED module substrate or PBC 134 is a ceramic or high conductivity plastic (e.g. Ceracon with thermal conductivity of 19 W/m° K). Heat is conducted from the LED module 128, to the top disc or portion 221 and then to the cylindrical wall 220 and fins 225 for eventual dissipation to the ambient environment via convection.

To aid in heat dissipation, a “lazy ruffle” style copper fin system 225 as shown in FIG. 14 is soldered or epoxied to the cylindrical wall 220. Copper is used for both the cylindrical wall 220 and fins 225 due to its high thermal conductivity and the need to minimize overall heat sink size. Heat is conducted from the LED module 128 and internally mounted electronics assembly 114 to the cylindrical wall 220 and then to the fin system 225. This minimizes the temperature gradient from the power producing components (LEDs and electronics) to the fins. The electronic PCB 114 has the hot components (consuming most power) mounted on one side and makes thermal contact to the inside of the cylindrical wall 220 using a thermally conductive pad material compressed between the PCB and the inside of the cylindrical wall 220. A compressed foam block is inserted between the backside of the PCB 114 and the other cylinder wall to apply pressure (minimum 15 PSI) on the PCB and thermal pad, to make good contact with the cylinder wall for heat conduction.

Referring to FIG. 15, the housing/heat sink 202 includes a shroud 226 disposed around the fins 225 to form the ducts 222. The white plastic shroud 226 is mounted to the outside of the fins to create “air ducts” 122 to aid in convective heat dissipation through a “chimney” type of affect. The lazy ruffle folded fin design was selected since this shape fin reduces the build-up of insulating boundary film layers that insulate the convective heat transfer from taking place. The ruffle fin shape allow more heat to be transferred in a given volume heat sink, desirable in this application where volume is limited. The white shroud 226 also reflects light and helps to obscure the heat sink structure when viewed though a fixture shade or lens. Optionally, the outer surface of the housing/heat sink 202 or shroud 226 will be painted, e.g., white, to allow light reflection off of the outer surface.

As air inside the ducts 122 heat up, it rises through normal buoyancy. This causes the air to move out the exhaust side 182 of the ducts 122 and cooler air to be drawn into the intake side 184 of housing 104 as shown FIG. 16. FIG. 16 illustrates the affect this process has on air circulation within the pendant type fixture. This process helps “push” warmer air out into the ambient environment, replenished by cooler air coming up the center of the fixture and through the intake 184.

While the disclosure has been shown and described with reference to certain preferred embodiments thereof, it will be understood by those skilled in the art that various changes in form and detail may be made therein without departing from the spirit and scope of the disclosure.

What is claimed is:

1. A light engine comprising:
a thermally conductive housing including a generally cylindrical wall defining a cavity, the cylindrical wall includes an inner surface and an outer surface, a plurality of ducted passageways being axially disposed on the outer surface;
a light module including at least one light emitting diode (LED) for producing visible light, the light module coupled to a first end of the housing, wherein heat generated by the at least one LED is conducted to the housing;
a current driver circuit arranged on a substrate, the substrate configured to be disposed in the cavity of the housing and electrically coupled to the light module for providing current to the at least one LED; and
a base configured for receiving input power and disposed on a second end of the housing, the base being electrically coupled to the current driver circuit.

2. The light engine as in claim 1, wherein the light module further comprises a metal core board configured for supporting the at least one LED and contacting at least an outer periphery of the cylindrical wall at the first end of the housing.

3. The light engine as in claim 2, further comprising an planar insulator disposed over the light module for protecting the light module, the insulator including at least one aperture for allowing the at least one LED to pass through.

4. The light engine as in claim 1, further comprising a optical diffuser for protecting the at least one LED coupled to an outer periphery of the cylindrical wall at the first end of the housing.

5. The light engine as in claim 1, wherein the housing is configured from a unitarily extruded material.

6. The light engine as in claim as in claim 5, wherein the housing is aluminum or thermally conductive plastic.

7. The light engine as in claim 1, wherein the cavity of the housing includes at least two channels for rigidly supporting the substrate.

8. The light engine as in claim 1, wherein the housing further comprises:
a thermally conductive ruffled member disposed around the cylindrical wall; and
a shroud disposed around the ruffled member to form the ducted air passageways.

9. The light engine as in claim 8, wherein the shroud is formed from a reflective material to reflect light emitted from the at least one LED.

10. The light engine as in claim 1, wherein the cavity is divided into first, second and third cavities, wherein the substrate is disposed in the second cavity, the second cavity being centrally disposed with the housing.

11. The light engine as in claim 1, wherein the base comprises a GU-24 style adapter.

12. The light engine as in claim 1, further comprising a temperature sensor coupled to the current driver circuit, wherein if the sensed temperature arises above a predetermined threshold value, the current driver circuit reduces or shuts off current to the light module.

13. A light engine comprising:
a thermally conductive housing including a generally cylindrical wall defining a cavity, the cylindrical wall includes an inner surface and an outer surface, a plurality of ducted passageways being axially disposed on the outer surface;
a light module including at least one light emitting diode (LED) for producing visible light, the light module including a circular, metal core board configured for supporting the at least one LED and contacting at least an outer periphery of the cylindrical wall at the first end of the housing, wherein heat generated by the at least one LED is conducted to the housing;
a current driver circuit arranged on a substrate, the substrate configured to be disposed in the cavity of the housing and electrically coupled to the light module for providing current to the at least one LED, the cavity of the housing includes at least two channels for rigidly supporting the substrate; and
a base configured for receiving input power and disposed on a second end of the housing, the base being electrically coupled to the current driver circuit.

14. The light engine as in claim 13, wherein the plurality of ducted passageways includes a continuous outer surface configured to reflect light emitted from the at least one LED.

15. The light engine as in claim 14, wherein the cavity is divided into first, second and third cavities, wherein the substrate is disposed in the second cavity, the second cavity being centrally disposed with the housing.

16. The light engine as in claim 15, wherein the second cavity is filled with potting material.
